(19) United States
(12) Patent Application Publication
(10) Pub. No.: US 2020/0357373 A1
(43) Pub. Date: Nov. 12, 2020

(54) Reduction of Sound Propagation Between Spaces Divided by a Retractable Wall

(71) Applicant: Hall Labs, LLC, Provo, UT (US)

(72) Inventors: David R. Hall, Provo, UT (US); Benjamin Jensen, Orem, UT (US); Jonathan Marshall, Mapleton, UT (US)

(73) Assignee: Hall Labs, LLC, Provo, UT (US)

(21) Appl. No.: 16/404,741

(22) Filed: May 7, 2019

(51) Int. Cl. G10K 11/162; E04B 1/99; E06B 9/58; E06B 3/01; E06B 5/20; E06B 7/20

(52) U.S. Cl. CPC G10K 11/162; E04B 1/99; E06B 7/20; E06B 3/01; E06B 5/20; E06B 9/582

(57) ABSTRACT

Methods and systems for reducing sound propagation between spaces divided by a retractable wall are disclosed. A retractable wall is configured to divide a space when deployed. An edge of the retractable wall is disposed into a track with a channel when the retractable wall is deployed. A bladder is configured to inflate when the retractable wall is deployed and to press the edge of the retractable wall. In this manner, sound propagation through any gaps is reduced.

### TECHNICAL FIELD

This invention relates generally to sound reduction.

### BACKGROUND

Retractable walls allow the separation of large spaces into smaller spaces, with a return to the large spaces when desired. However, retractable walls can present difficulties in sound proofing. Methods and systems for reduction of sound propagation across retractable walls that are simple and effective are needed.

### SUMMARY

In a first aspect, the disclosure provides a system for reducing sound propagation between spaces divided by a retractable wall. A retractable wall is configured to divide a space when deployed. An edge of the retractable wall is disposed into a track with a channel when the retractable wall is deployed. A bladder is configured to inflate when the retractable wall is deployed and to press against the edge of the retractable wall. In this manner, sound propagation through any gaps is reduced.

In a second aspect, the disclosure provides a method for reducing sound propagation between spaces divided by a retractable wall. A retractable wall is provided. A space is divided by deploying the retractable wall. An edge of the retractable wall is disposed into a track with a channel when the retractable wall is deployed. A bladder is inflated when the retractable wall is deployed that presses the edge of the retractable wall. In this manner, sound propagation through any gaps is reduced.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a cutaway view of a wall disposed in a channel of a track with a deflated bladder.

FIG. 2 is the cutaway view of FIG. 1 with an inflated bladder.

FIG. 3 is a cutaway view of two walls disposed in channels of two tracks with a deflated bladder.

FIG. 4 is the cutaway view of FIG. 3 with an inflated bladder.

FIG. 5 is an isometric view of a rollable wall partly closed.

FIG. 6 is an isometric view of the rollable wall of FIG. 5, with the rollable wall closed.

FIG. 7 is an isometric view of a retractable wall deploying as a sheet partly closed.

FIG. 8 is an isometric view of the retractable wall of FIG. 7, with the retractable wall closed.

FIG. 9 is a block diagram showing a method for reducing sound propagation between spaces divided by a retractable wall.

FIG. 10 is a block diagram showing a method for reducing sound propagation between spaces divided by a retractable wall.

FIG. 11 is a cutaway view of a wall disposed in a channel of a track with two deflated bladders.

FIG. 12 is the cutaway view of FIG. 11 with inflated bladders.

FIG. 13 is a cutaway view of a wall disposed in a channel of a track with a deflated C-shape bladder.

FIG. 14 is the cutaway view of FIG. 13 with an inflated bladder.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “bladder” is meant to refer to an inflatable, flexible object that can be inflated by any normal inflation means, such as hydraulics or pneumatics.

As used herein, “spaces” are meant to refer to any volumes such as rooms, areas, and places.

Sound propagation between spaces separated by retractable walls is reduced by the systems and methods disclosed herein. A significant source of sound between spaces separated by retractable walls is sound propagation through the air gap between the edge of the retractable walls and the track through which the edge deploys. This air gap could be eliminated by having the edge rub against the track during deployment, but at the cost of larger motors and faster wear. The systems and methods disclosed reduce or even eliminate this air gap. In addition to reducing sound propagation through the retractable wall, closing gaps can also help reduce or eliminate the passage of air around the retractable wall, such as when there is a pressure differential across the two spaces divided by the retractable wall. Blocking the passage of air around the retractable wall can eliminate whistling or other annoyances.

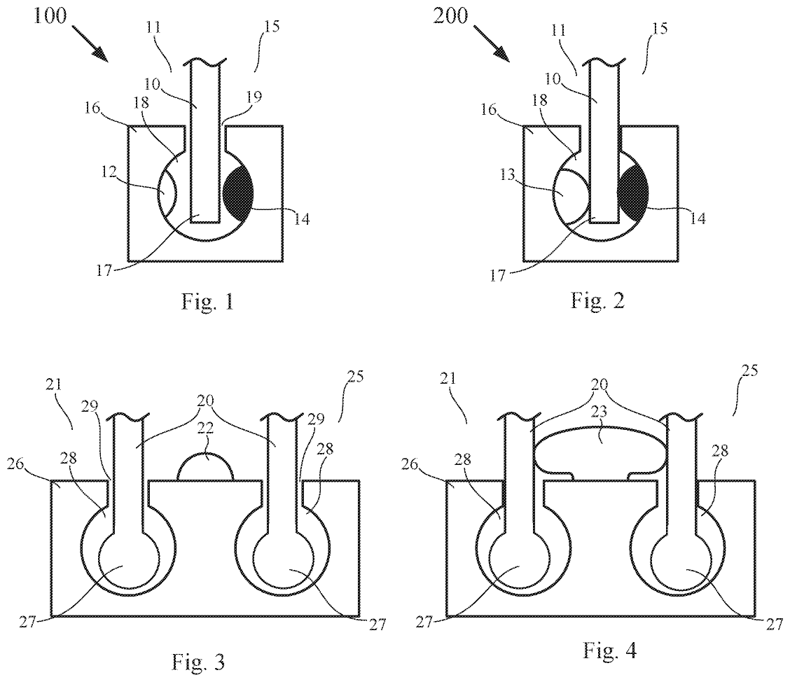

Now referring to FIG. 1 and FIG. 2, FIG. 1 is a cutaway view of a wall disposed in a channel of a track with a deflated bladder at 100 that may be used in one embodiment of the present invention. FIG. 2 is the cutaway view of FIG. 1 with an inflated bladder at 200. The retractable wall 10 is configured to divide space 11 from space 15. The retractable wall 10 is deploying in FIG. 1 and is deployed in FIG. 2. The retractable wall 10 deploys into a channel 18 of a track 16. The bladder 12 is deflated as the retractable wall 10 is deploying, as in FIG. 1, and is configured to inflate as an inflated bladder 12 when the retractable wall 10 is deployed, as in FIG. 2. The inflated bladder 12 presses an edge 17 of the retractable wall 10 against a rubber bumper 14 in the channel 18. This closes the air gap 19 around the edge 17 of the retractable wall 10, reducing sound propagation through the air gap 19 by eliminating the air gap 19.

Preferably, the bladder is made of an elastic, rubber-like material that expands when inflated to press against the edge of the wall. Most preferably, the material is an elastomer, such as butyl rubber. Alternatively, the bladder is made of a non-elastic material that is formed into a bellows-like construction, whereby the bladder can also be inflated to press against the edge of the wall. In either event, the important feature is that the bladder is capable of pressing against the edge of the wall when inflated.

Preferably, the bladder is deflated and does not contact the edge of the wall during deployment or retraction. Nevertheless, it may be preferable to select a material, coating or other means for the bladder and/or edge of the wall, so as to reduce wear by friction between the two.

Preferably, the bladder is pneumatic, i.e. inflated with air, by a simple air pump connected by a tube to the bladder. Activation of the pump to inflate the bladder is preferably synchronized with the deployment of the wall. Most preferably, the same pump also works to deflate the bladder prior to the wall being retracted.

Alternatively, the bladder is inflated with a hydraulic fluid, such as water or mineral oil. In such embodiments, the bladder is inflated when the hydraulic fluid is pumped from a reservoir into the bladder.

Preferably, the track is formed by extrusion of a material, such as aluminum or a somewhat rigid polymer. The track can be attached to the wall by conventional means. Preferably, the channel formed in the track is key-hole shaped as shown in FIG. 1. In this way, the bladder 12 and bumper 14 can reside within the channel and now be exposed. In some embodiments, the edge of the retractable wall is captured within such a key-hole shaped channel.

In an alternative embodiment, such as that shown in FIGS. 13 and 14, the bladder 72 is configured to simultaneously press against both sides of the edge 77 when inflated. The bladder in this embodiment is preferably C-shaped and presses against both sides of the edge and the end of the edge at the same time when inflated. FIG. 13 is a cutaway view of a wall disposed in a channel of a track with the C-shaped deflated bladder at 1300. FIG. 14 is the cutaway view of FIG. 13 with the C-shaped bladder inflated at 1400. The retractable wall 70 is configured to divide space 71 from space 75. The retractable wall 70 is deploying in FIG. 13 and is deployed in FIG. 14. The retractable wall 70 deploys into a channel 78 of a track 76.

The bladder 72 is deflated as the retractable wall 70 is deploying, as in FIG. 13, and is configured to inflate as an inflated bladder 72 when the retractable wall 70 is deployed, as in FIG. 14. The inflated bladder 72 squeezes both sides of the edge and the end of the edge in the channel 78. This closes the gap 79 around the edge 77 of the retractable wall 70, reducing sound propagation through the gap 79 by eliminating the gap 79.

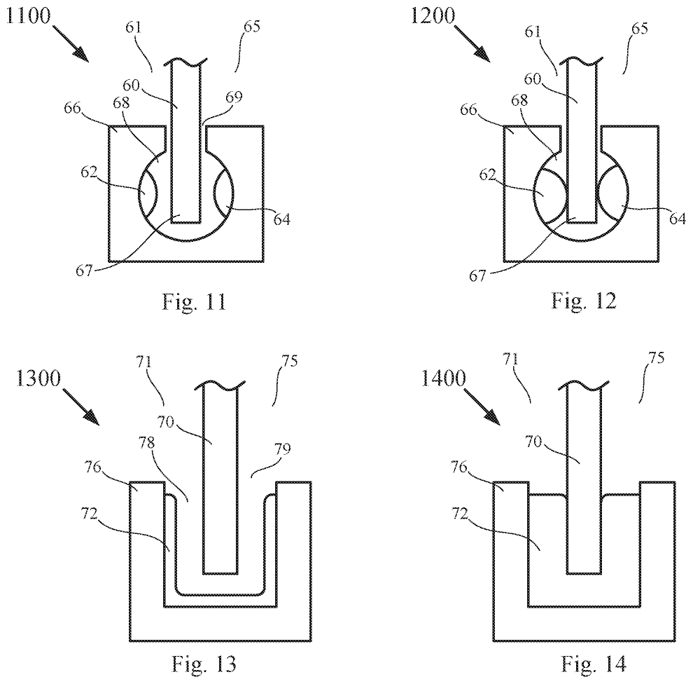

Now referring to FIG. 11 and FIG. 12, FIG. 11 is a cutaway view of a wall disposed in a channel of a track with two deflated bladders at 1100 that may be used in one embodiment of the present invention. FIG. 12 is the cutaway view of FIG. 11 with inflated bladders at 1200. The retractable wall 60 is configured to divide space 61 from space 65. The retractable wall 60 is deploying in FIG. 11 and is deployed in FIG. 12. The retractable wall 60 deploys into a channel 68 of a track 66. The bladders 62 and 64 are deflated as the retractable wall 60 is deploying, as in FIG. 11, and are configured to inflate as inflated bladders 62 and 64 when the retractable wall 60 is deployed, as in FIG. 12. The inflated bladders 62 and 64 squeeze an edge 67 of the retractable wall 60 between them in the channel 68. This closes the gap 69 around the edge 67 of the retractable wall 60, reducing sound propagation through the gap 69 by eliminating the gap 69.

Now referring to FIG. 3 and FIG. 4, FIG. 3 is a cutaway view of a wall with two sides disposed in channels of tracks with a deflated bladder at 300 that may be used in one embodiment of the present invention. FIG. 4 is the cutaway view of FIG. 3 with an inflated bladder at 400. The retractable wall 20 is configured to divide space 21 from space 25. The retractable wall 20 is deploying in FIG. 3 and is deployed in FIG. 4. The retractable wall 20 deploys into channels 28 of tracks 26. The bladder 22 is deflated as the retractable wall 20 is deploying, as in FIG. 3, and is configured to inflate as an inflated bladder 23 when the retractable wall 20 is deployed, as in FIG. 4. The inflated bladder 23 presses edges 27 of the retractable wall 20 against the channels 28. This closes the gaps 29 around the edges 27 of the retractable walls 20, reducing sound propagation through the gaps 29 by eliminating the gaps 29.

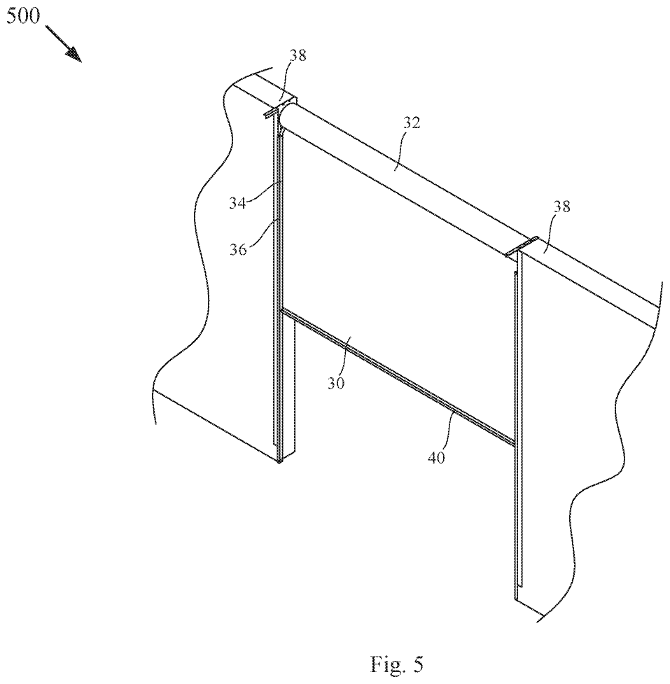

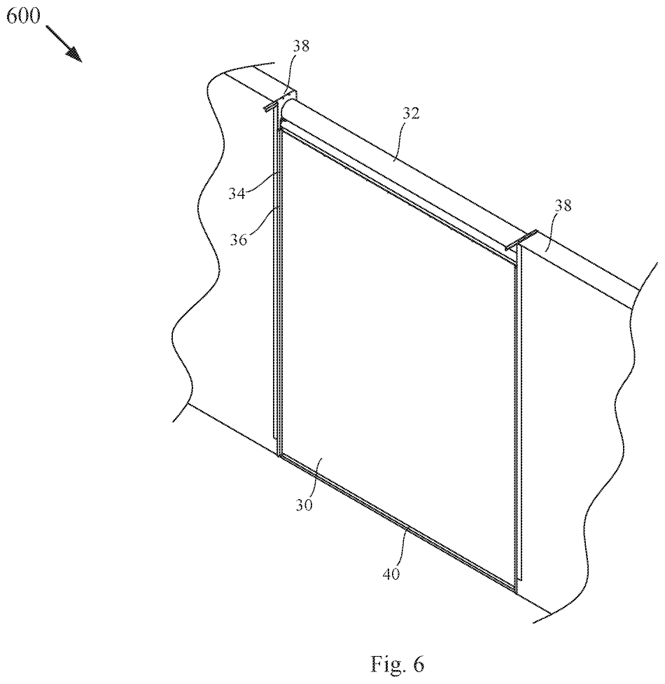

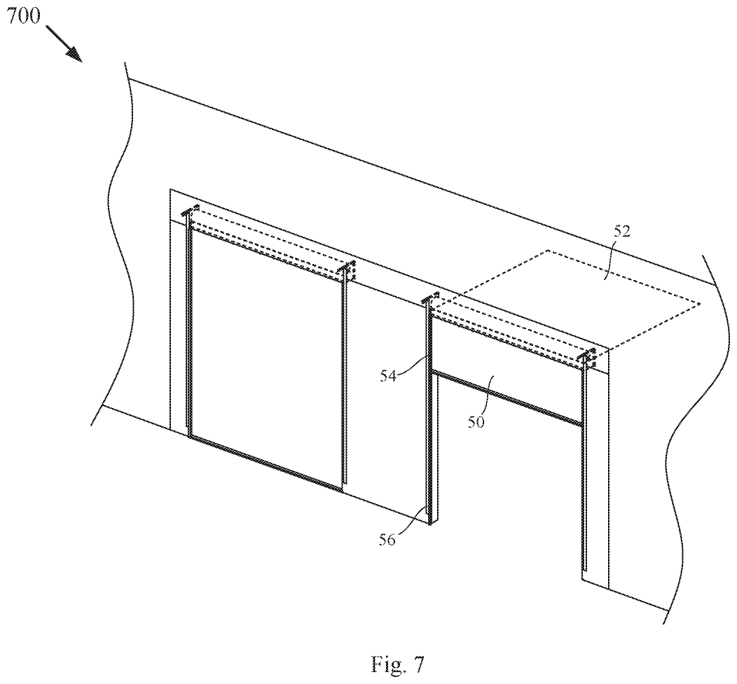

Now referring to FIG. 5 and FIG. 6, FIG. 5 is an isometric view of a rollable wall at 500, partly closed, that may be used in one embodiment of the present invention. FIG. 6 is an isometric view of the rollable wall of FIG. 5 at 600, with the rollable wall closed. The rollable wall 30 has edges 34 that are deployed in tracks 36. The tracks 36 are attached to the permanent walls 38. In one embodiment, a close-up view of the tracks 36 is shown in FIG. 1 while the wall is rolling and in FIG. 2 when the wall 30 is fully closed. The rollable wall 30 is rolled up on spool 32 when open.

The rollable wall 30, when closed and the bladder is inflated, reduces sound propagation between the rooms separated by the rollable wall 30. In some embodiments, the floor is metal. A bottom edge of the retractable wall 30 has a magnetic strip 40 that attaches to the floor. The magnetic strip 40 preferably comprises one or more permanent magnets. Alternatively, the strip can include one or more electromagnets that can be switched on and off to attach and release the wall. The floor preferably includes a strip of ferromagnetic material, e.g. containing iron. Alternatively, the floor can include a permanent or electromagnet.

As shown in FIGS. 5 and 6, the retractable wall is preferably a rollable wall. Such a wall is preferably made of a pliable material, such as a vinyl polymer, which includes a filler to add density. Preferably, the edges of the rollable wall include some form of reinforcement, such as a hem or an extra strip of material, in order to keep the edge from wearing out and to maintain the dimensional stability of the wall.

Preferably, the spool 32 is operated by a conventional motor with standard safety features. Alternatively, the spool is spring-loaded and the wall is deployed by either manual or automated pulling of the wall down toward the floor. For example, cables can be attached to the bottom corners of the retractable wall. When pulled, those cables can operate to deploy the wall. When the cables are loosened, the wall can be retracted by the spring-loaded spool.

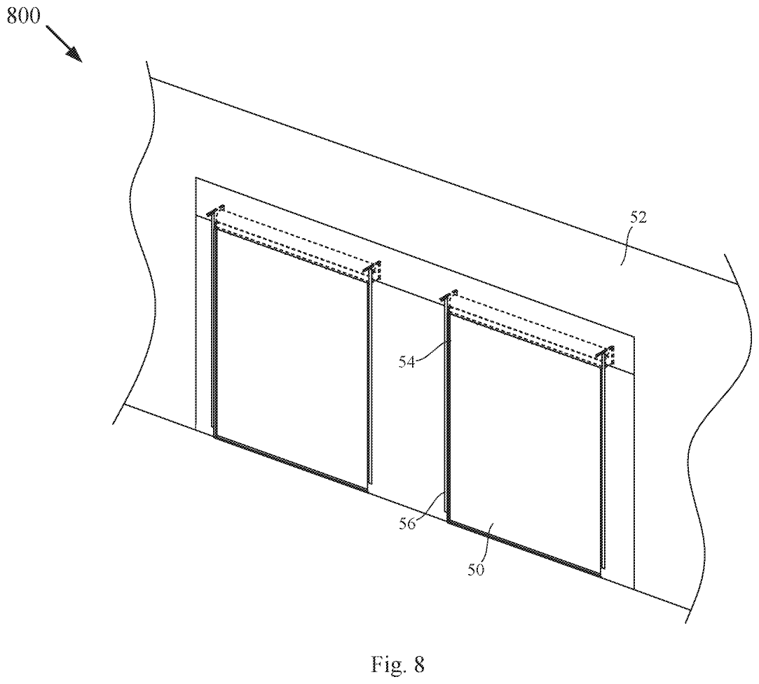

Now referring to FIG. 7 and FIG. 8, FIG. 7 is an isometric view of a retractable wall at 700 deploying as a sheet, partly closed, that may be used in one embodiment of the present invention. FIG. 8 is an isometric view of the retractable wall of FIG. 7, with the retractable wall closed at 800. The retractable wall 50 has edges 54 that are deployed in tracks 56. In one embodiment, a close-up view of the tracks 56 is shown in FIG. 1 while the wall is retracting or deploying and in FIG. 2 when the wall 50 is fully closed. The retractable wall 50 is retracted up into cavity 52 when open. The retractable wall 50, when closed, reduces sound propagation between the outside and the interior.

In alternative embodiments, the retractable wall is made up of either horizontally or vertically folding panels. If the retractable wall comprises horizontally folding panels, it may be preferable for the tracks to be actuated outward when the wall is being moved and then actuated inward so as to capture the two side edges of the retractable wall when deployed in place.

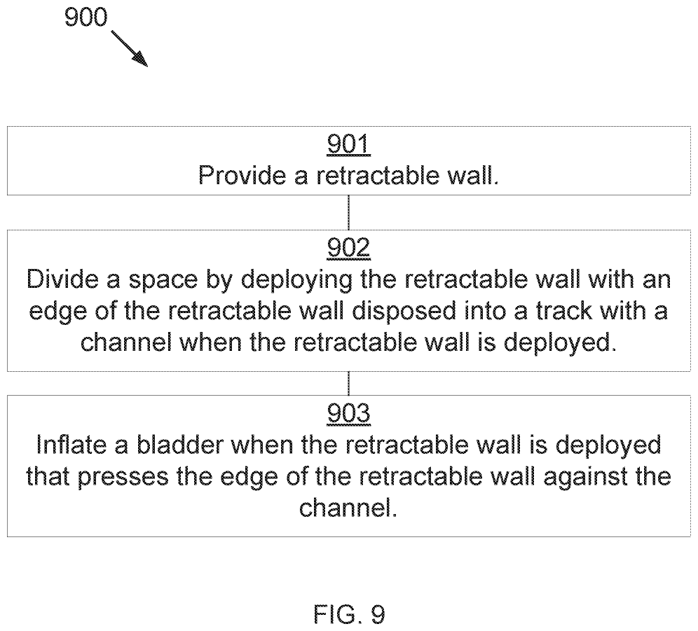

FIG. 9 is a block diagram showing a method 900 for reducing sound propagation between spaces divided by a retractable wall that may be used in one embodiment of the present invention. At 901, a retractable wall is provided. At 902, a space is divided by deploying the retractable wall. An edge of the retractable wall is disposed into a track with a channel when the retractable wall is deployed. At 903, a bladder is inflated when the retractable wall is deployed that presses the edge of the retractable wall against the channel. In this manner, sound propagation through any gaps is reduced.

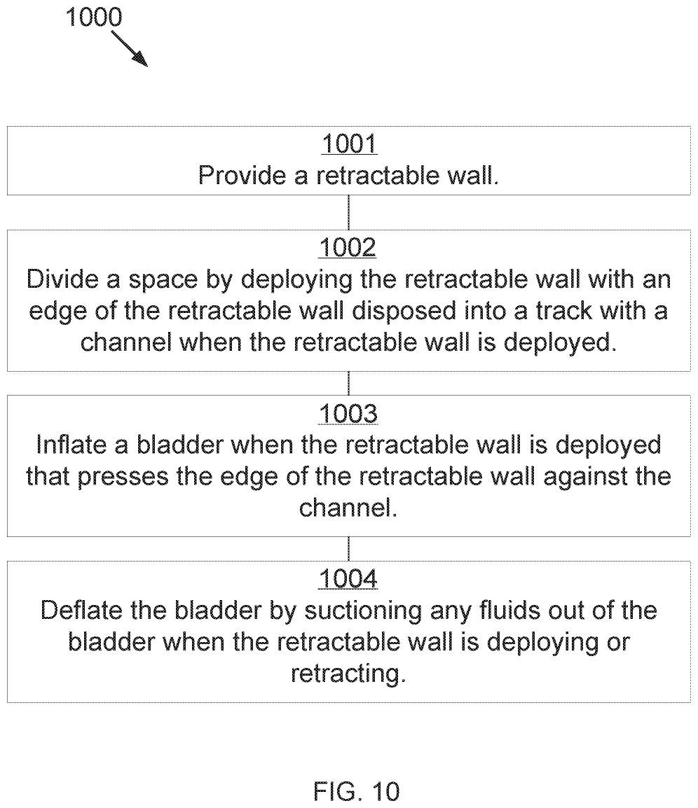

FIG. 10 is a block diagram showing a method 1000 for reducing sound propagation between spaces divided by a retractable wall that may be used in one embodiment of the present invention. At 1001, a retractable wall is provided. At 1002, a space is divided by deploying the retractable wall. An edge of the retractable wall is disposed into a track with a channel when the retractable wall is deployed. At 1003, a bladder is inflated when the retractable wall is deployed that presses the edge of the retractable wall against the channel. In this manner, sound propagation through any gaps is reduced. At 1004, the bladder is deflated by suctioning any fluids out of the bladder when the retractable wall is deploying or retracting. In other words, when the wall is moving, the bladder is out of the way ad doesn't rub against the moving wall.

In a preferred embodiment, the retractable wall deploys from the ceiling. In an alternate embodiment, the retractable wall deploys from an adjacent wall.

As noted above, in some embodiments, the bladder is inflated by pressurized hydraulic fluid. In alternate embodiments, the bladder is inflated by pressurized air. In some embodiments, the bladder is deflated by suctioning any fluids out of the bladder while the retractable wall is deploying or retracting. This results in the bladder being out of the path of the retractable wall while the retractable wall is deploying or retracting.

In some embodiments, an other edge of the wall is configured to magnetically attach to the floor, the ceiling, or an other wall when the wall is deployed.

In a preferred embodiment, the bladder blocks all gaps along the edge of the retractable wall when the bladder is inflated.

The invention has been described with reference to various specific and preferred embodiments and techniques. Nevertheless, it is understood that many variations and modifications may be made while remaining within the spirit and scope of the invention.

What is claimed is:

1. A system for reducing sound propagation between spaces divided by a retractable wall comprising:
a retractable wall configured to divide a space when deployed;
a track with a channel into which an edge of the retractable wall is disposed when the retractable wall is deployed; and
a bladder configured to inflate when the retractable wall is deployed and to press against the edge of the retractable wall, to thereby close gaps between the edge of the retractable wall and the channel;
whereby sound propagation through such gaps is reduced.

2. The invention of claim 1, wherein the retractable wall is configured to deploy by rolling off a spool and retract by rolling onto the spool.

3. The invention of claim 1, wherein the retractable wall is configured to deploy as a sheet out of a cavity and retract as a sheet back into the cavity.

4. The invention of claim 1, wherein the retractable wall is configured to deploy from the ceiling.

5. The invention of claim 1, wherein the retractable wall is configured to deploy from an adjacent wall.

6. The invention of claim 1, wherein the bladder is configured to be inflated by pressurized hydraulic fluid.

7. The invention of claim 1, wherein the bladder is configured to be inflated by pressurized air.

8. The invention of claim 1, wherein the bladder is further configured to deflate by suctioning any fluids out of the bladder when the retractable wall is deploying or retracting, resulting in the bladder being out of a path of the retractable wall while the retractable wall is deploying or retracting.

9. The invention of claim 1, wherein an other edge of the wall is configured to magnetically attach to a floor, a ceiling, or an other wall, when the wall is deployed.

10. The invention of claim 1, wherein the bladder is configured to block all gaps along the edge of the retractable wall when the bladder is inflated.

11. The invention of claim 1, wherein the retractable wall comprises two sides separated by a cavity.

12. The invention of claim 11, wherein the bladder is further configured to press against the two sides simultaneously.

13. The invention of claim 11, further comprising an other bladder, wherein the bladder presses against a first of the two sides and wherein the other bladder presses against a second of the two sides.

14. The invention of claim 1, wherein the bladder is configured to inflate and press simultaneously against both sides of the edge of the retractable wall.

15. The invention of claim 1, wherein the channel comprises a bumper against which the bladder presses the edge of the retractable wall.

16. A method for reducing sound propagation between spaces divided by a retractable wall comprising:
providing a retractable wall;
dividing a space by deploying the retractable wall, an edge of the retractable wall disposed into a track with a channel when the retractable wall is deployed; and
inflating a bladder when the retractable wall is deployed that presses the edge of the retractable wall, to thereby close gaps between the edge of the retractable wall and the channel;
whereby sound propagation through such gaps is reduced.

17. The invention of claim 16, wherein the retractable wall deploys by rolling off a spool and retracts by rolling onto the spool.

18. The invention of claim 16, wherein the retractable wall deploys as a sheet out of a cavity and retracts as a sheet back into the cavity.

19. The invention of claim 16, wherein the retractable wall deploys from the ceiling.

20. The invention of claim 16, further comprising deflating the bladder by suctioning any fluids out of the bladder when the retractable wall is deploying or retracting, resulting in the bladder being out of a path of the retractable wall while the retractable wall is deploying or retracting.
